(19) United States
(12) Patent Application Publication
(10) Pub. No.: US 2015/0117186 A1
(43) Pub. Date: Apr. 30, 2015

(54) WIRELESS ACCESS POINT DEVICE AND BAND CONTROL METHOD

(71) Applicant: Mitsubishi Electric Corporation, Tokyo (JP)

(72) Inventor: Shigeru Uchida, Tokyo (JP)

(73) Assignee: Mitsubishi Electric Corporation, Tokyo (JP)

(21) Appl. No.: 14/394,177

(22) PCT Filed: May 30, 2013
(86) PCT No.: PCT/JP13/65061

§ 371 Date: Oct. 13, 2014

(30) Foreign Application Priority Data
Nov. 13, 2012 (JP) 2012-249344

(51) Int. Cl. H04W 72/04

(52) U.S. Cl. CPC H04W 72/0486
USPC 370/230

(57) ABSTRACT

A wireless access point device that is connected to one or more wireless client terminals and communicates with each of the wireless client terminals by using one of a plurality of bandwidths, and includes a transmission managing unit that individually determines a transmission rate with respect to each of the connected wireless client terminals; and a used bandwidth determining unit that calculates an approximation of a system communication capacity on the basis of the transmission rate and the number of the connected wireless client terminals and determines a bandwidth to be used by subjecting the approximation to determination based on a threshold.

### FIELD

The present invention relates to a wireless access point device and a band control method.

### BACKGROUND

IEEE (Institute of Electrical and Electrons Engineers) 802.11n, which is a wireless LAN (Local Area Network) standard realizing the transmission speed of over 100 Mbps, defines a transmission mode in which a bandwidth of 40 MHz is used in addition to the bandwidth of 20 MHz that is used in the conventional IEEE 802.11 standard. In IEEE 802.11n, the backward compatibility of the legacy terminals that use IEEE 802.11a/b/g is taken into consideration and the 20-MHz bandwidth, referred to as the “primary channel”, is used for transmitting control frames and data frames with respect to the legacy terminals. When the 40-MHz bandwidth is used, two channels of 20-MHz bandwidth are combined and used. The extended 20-MHz bandwidth is referred to as the “secondary channel”.

With IEEE 802.11ac, which is currently being standardized, the intention is to standardize a transmission mode that uses the bandwidths of 80 MHz and 160 MHz in addition to using 40 MHz. Consequently, while the speed of the wireless LAN is further increased, the frequency used—frequency being finite—becomes wideband; therefore, there is interference from surrounding other wireless LAN equipment and other wireless systems that use the same frequency band, thus a problem arises in that the transmission speed is not stabilized. In contrast, because the speeded-up wireless LAN interferes with other wireless LAN equipment and other wireless systems, there is a possibility that the transmission efficiency is reduced in view of the whole system using the same frequency band.

In order to address such a problem, an invention (wireless communication device and wireless communication method) is disclosed in Patent Literature 1. In the invention, the wireless communication device measures the frame error rate when frames are transmitted in the bandwidth mode “40 MHz” and in the bandwidth mode “Duplicate”; performs determination based on thresholds on the frame error rates; and, when it is determined that transmission in the bandwidth mode “40 MHz” is not appropriate, specifies a transmission bandwidth from the data reception terminal to the data transmission terminal, which makes it possible to prevent the data transmission terminal from continuing to transmit 40-MHz frames even though the data reception terminal cannot receive 40-MHz frames and thus to prevent the bands in a whole BSS (Basic Service Set) from being wasted and prevent the transmission power of the terminals from being wasted.

### CITATION LIST

### Patent Literature

Patent Literature 1: Japanese Patent Application Laid-open No. 2008-199102

### SUMMARY

### Technical Problem

However, in the case of the wireless communication device described in Patent Literature 1, when an adaptive modulation algorithm is operated independently from the disclosed wireless communication scheme, the transmission rate (including a case of being uniquely determined by a pair of an MCS (Modulation Coding Scheme) Index and a GI (Guard Interval) length and the used bandwidth) changes in accordance with the communication state and the frame error rate is suddenly improved in some cases; therefore, the frame error rate cannot be accurately measured. In other words, an optimum bandwidth mode cannot be selected and thus the transmission efficiency is reduced. On the other hand, in order to accurately measure the frame error rate, for example, when control is performed such that the transmission rate does not change while the frame error rate is measured and the transmission rates to be used in the bandwidth mode “40 MHz” and the bandwidth mode “Duplicate” are matched, there are problems in that the control method becomes complicated and an appropriate adaptive modulation control cannot be performed while the frame error rate is measured.

The present invention has been achieved in view of the above and an object of the present invention is to obtain a wireless access point device and a band control method capable of improving the transmission efficiency while preventing the control from the being complicated even when an adaptive modulation algorithm is operated independently.

### Solution to Problem

In order to solve the above problems and achieve the object, the present invention relates to a wireless access point device that is connected to one or more wireless client terminals and communicates with each of the wireless client terminals by using one of a plurality of bandwidths, the device including: a transmission-rate determining unit that individually determines a transmission rate with respect to each of connected wireless client terminals; a calculating unit that calculates an approximation of a system communication capacity on a basis of the transmission rate and number of the connected wireless client terminals; and a bandwidth determining unit that determines a bandwidth to be used by subjecting the approximation to determination based on a threshold.

### Advantageous Effects of Invention

According to the present invention, an effect is obtained where a stable throughput can be provided and the transmission efficiency can be improved. Moreover, an effect is obtained where the transmission efficiency can be improved in the whole system that uses the same frequency band and includes other systems.

### BRIEF DESCRIPTION OF DRAWINGS

FIG. 1 is a diagram illustrating an example of the configuration of a first embodiment of a wireless communication system that includes a wireless access point device according to the present invention.

FIG. 2 is a diagram illustrating an example of the configuration of the wireless access point device in the first embodiment.

FIG. 3 is a diagram illustrating an example of thresholds to be used in an operation for determining the system bandwidth in the first embodiment.

FIG. 4 is a diagram illustrating another example of thresholds to be used in an operation for determining the system bandwidth in the first embodiment.

FIG. 5 is a diagram illustrating an example of the configuration of a wireless access point device in a second embodiment.

FIG. 6 is a diagram illustrating an example of thresholds to be used in an operation for determining the system bandwidth in a third embodiment.

FIG. 7 is a diagram illustrating an example of thresholds to be used in an operation for determining the system bandwidth in a fourth embodiment.

FIG. 8 is an explanatory diagram of an operation of a wireless access point device in a fifth embodiment.

FIG. 9 is an explanatory diagram of the operation of the wireless access point device in the fifth embodiment.

### DESCRIPTION OF EMBODIMENTS

Exemplary embodiments of a wireless access point device and a band control method according to the present invention will be explained below in detail with reference to the drawings. This invention is not limited to the embodiments.

### First Embodiment

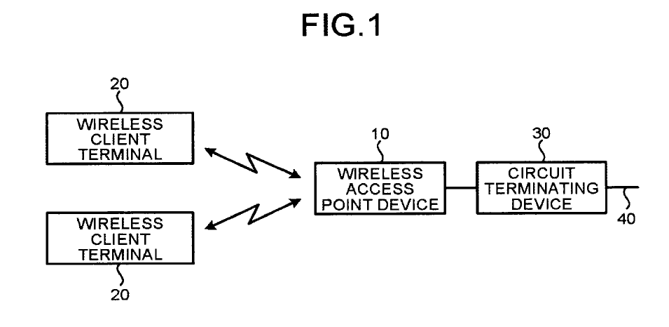

FIG. 1 is a diagram illustrating an example of the configuration of a first embodiment of a wireless communication system that includes a wireless access point device according to the present invention.

The wireless communication system according to the present embodiment is configured to include a wireless access point device 10, one or more wireless client terminals 20, and a circuit terminating device 30. The wireless access point device 10 according to the present invention is, for example, installed in a home and performs wireless communication with the wireless client terminals 20, whereby a wireless LAN is constructed. The number of the wireless client terminals 20 is not limited to the example illustrated in FIG. 1. In the following explanation, the wireless client terminal 20 is referred to as the terminal 20 in some cases.

The wireless communication system in the present embodiment is constructed to correspond to the infrastructure mode of the IEEE 802.11 standard. In the example in FIG. 1, the wireless access point device 10 is connected to a communication line 40 through the circuit terminating device 30. According to this example, the wireless client terminals 20 can be connected to the Internet and the like through the wireless access point device 10, the circuit terminating device 30, and the communication line 40. The wireless access point device 10 may be, for example, integrated with the circuit terminating device 30. The wireless access point device 10 may have a function equivalent to a home gateway device.

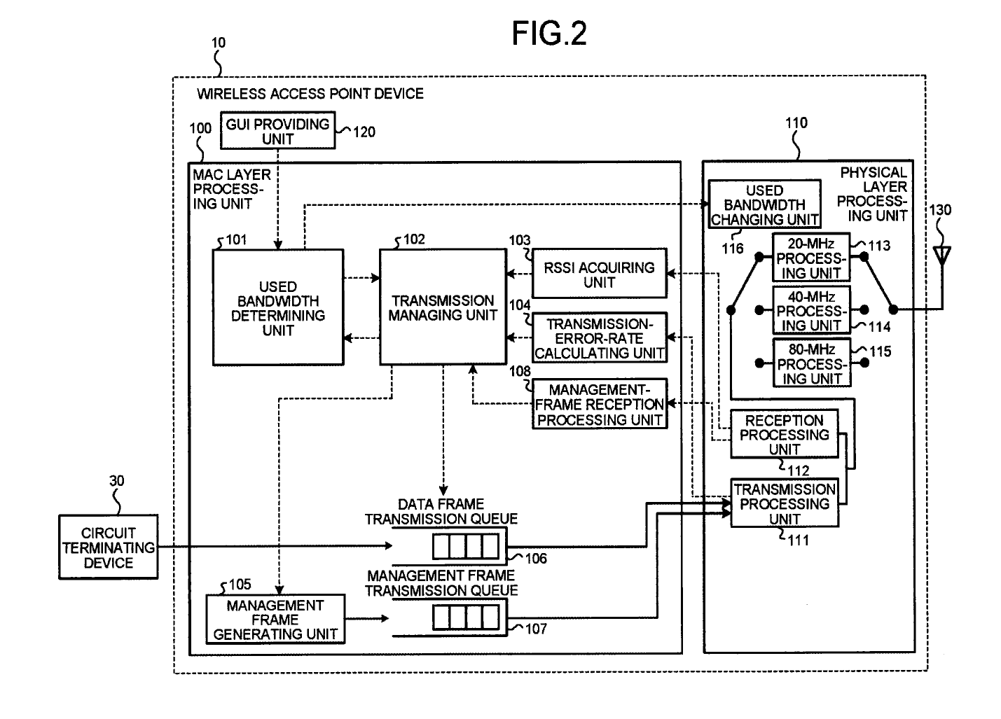

FIG. 2 is a diagram illustrating an example of the configuration of the wireless access point device 10. As illustrated in FIG. 2, the wireless access point device 10 includes, as main components, an MAC layer processing unit 100, a physical layer processing unit 110, and a GUI (Graphical User Interface) providing unit 120. An antenna 130 is connected to the physical layer processing unit 110. The circuit terminating device 30 is also illustrated in FIG. 2. In FIG. 2, the solid lines indicate delivery of signals, such as frames, and the broken lines indicate delivery of various other pieces of information.

The MAC layer processing unit 100 includes a used bandwidth determining unit 101, a transmission managing unit 102, an RSSI acquiring unit 103, a transmission-error-rate calculating unit 104, a management frame generating unit 105, a data frame transmission queue 106, a management frame transmission queue 107, and a management-frame reception processing unit 108. The used bandwidth determining unit 101 operates as a calculating unit and a bandwidth determining unit. The physical layer processing unit 110 includes a transmission processing unit 111, a reception processing unit 112, a 20-MHz processing unit 113, a 40-MHz processing unit 114, an 80-MHz processing unit 115, and a used bandwidth changing unit 116. Various processes and various functions (various components described above) by the MAC layer processing unit 100 and the physical layer processing unit 110 may be implemented as software by the processor executing a predetermined program or may be implemented as hardware by using circuits and devices configured for the above purposes. Alternatively, they may be implemented as a combination of software and hardware.

In the MAC layer processing unit 100, the used bandwidth determining unit 101 determines the bandwidth to be used for communication with each of the wireless client terminals 20. The transmission managing unit 102 determines the transmission rate when frames are transmitted to the wireless client terminals 20. The transmission rate is determined for each of the wireless client terminals 20. The RSSI acquiring unit 103 acquires an RSSI (Received Signal Strength Indication) measured by the reception processing unit 112 of the physical layer processing unit 110. The transmission-error-rate calculating unit 104 acquires information on the number of frames transmitted to the wireless client terminals 20 and information on the number of frames that are transmitted successfully (or the number of frames that are not transmitted successfully) to the wireless client terminals 20 from the transmission processing unit 111 of the physical layer processing unit 110 and calculates the transmission error rate. The management frame generating unit 105 generates predetermined management frames to be transmitted to the wireless client terminals 20. The data frame transmission queue 106 temporarily holds data frames to be transmitted to the wireless client terminals 20. The management frame transmission queue 107 temporarily holds management frames to be transmitted to the wireless client terminals 20. The management-frame reception processing unit 108 extracts various pieces of information contained in the management frames received from the wireless client terminals 20.

In the physical layer processing unit 110, the transmission processing unit ill extracts data frames stored in the data frame transmission queue 106 of the MAC layer processing unit 100 and management frames stored in the management frame transmission queue 107 and transmits them to the wireless client terminal 20 that is the destination. The reception processing unit 112 receives various frames from the wireless client terminals 20. When the used bandwidth is 20 MHz, the 20-MHz processing unit 113 converts the signals output from the transmission processing unit 111 into wireless signals to be transmitted from the antenna 130 and converts the wireless signals received by the antenna 130 into signals to be processed in the reception processing unit 112. When the used bandwidth is 40 MHz, the 40-MHz processing unit 114 converts the signals output from the transmission processing unit 111 into wireless signals to be transmitted from the antenna 130 and converts the wireless signals received by the antenna 130 into signals to be processed in the reception processing unit 112. When the used bandwidth is 80 MHz, the 80-MHz processing unit 115 converts the signals output from the transmission processing unit 111 into wireless signals to be transmitted from the antenna 130 and converts the wireless signals received by the antenna 130 into signals to be processed in the reception processing unit 112. The used bandwidth changing unit 116 selects a processing unit to be used (switches to the processing unit to be used) from among the 20-MHz processing unit 113, the 40-MHz processing unit 114, and the 80-MHz processing unit 115 in accordance with the determination result in the used bandwidth determining unit 101 of the MAC layer processing unit 100.

The GUI providing unit 120 is a functional unit that enables the user to set various settings related to wireless communication of the device (the wireless access point device 10). The GUI providing unit 120 stores default setting values of the device and also stores user setting information (information regarding setting changes made by the user). For example, when the device is turned on and is started, the GUI providing unit 120 requests the user to set various settings related to wireless communication and stores the content set by the user as user setting information. Using the GUI is exemplified as the setting method; however, using the GUI is not the only example and the user setting information may be acquired by using other methods and then stored.

The operation of the wireless access point device 10 in the present embodiment will be explained below. The explanation will focus on the characteristic operation and the explanation of other general operations will be omitted.

First, the operation of the MAC layer processing unit 100, specifically, the used bandwidth determining process performed in the MAC layer processing unit 100 will be explained.

In the MAC layer processing unit 100, when the used bandwidth is determined, first, the transmission managing unit 102 determines the transmission rate to be used when data frames are transmitted to the wireless client terminals 20. Specifically, the transmission managing unit 102 acquires the RSSI value of each of the terminals 20 acquired from the reception processing unit 112 of the physical layer processing unit 110 by the RSSI acquiring unit 103 and the transmission error rate with respect to each of the terminals 20 calculated on the basis of the information (frame-transmission success/failure information or information equivalent thereto) acquired from the transmission processing unit 111 of the physical layer processing unit 110 by the transmission-error-rate calculating unit 104. Then, the transmission managing unit 102 determines the communication scheme to be selected (for example, IEEE 802.11b, IEEE 802.11g, IEEE 802.11n, and the like) and a transmission rate for the bandwidth of the selected communication scheme on the basis of the acquired information (RSSI value and transmission error rate), the upper limit (latest value) of the bandwidth that is determined by the used bandwidth determining unit 101 and is used in the system, and the terminal performance information acquired from the terminals 20 by the management-frame reception processing unit 108 when the process of connecting the device and the terminals 20 is performed. The algorithm for determining the transmission rate (as described above, may be a pair of an NCS Index and a GI length or index information indicating the transmission rate) is riot within the scope of the present invention. In other words, in FIG. 2, an example is illustrated in which the transmission rate is determined on the basis of the RSSI value and the transmission error rate with respect to the terminals 20; however, it is not limited to this, and, other information, such as feedback information for determining the transmission rate, may be acquired from each of the terminals 20 and the transmission rate may be determined on the basis of the acquired information. The transmission rate may be determined by using other methods.

The determination result in the transmission managing unit 102 (the determined communication scheme for each of the terminals 20 and the information on the transmission rate including the information on the bandwidth) is added, as information, to the data frames for the respective terminals 20 that accumulate in the data frame transmission queue 106 to be passed to the physical layer processing unit 110 together with the data frames. The determination result in the transmission managing unit 102 is also passed to the used bandwidth determining unit 101.

The used bandwidth determining unit 101, which has received the communication scheme and the information on the transmission rate described above, first refers to the user setting information stored in the GUI providing unit 120 and determines the bandwidth to be used by default. Control may be performed so as not to exceed the upper limit of the bandwidth to be used in the system described in the present embodiment and the following embodiments. When the used bandwidth determining unit 101 determines the bandwidth to be used, the used bandwidth determining unit 101 notifies the transmission managing unit 102 of the determined bandwidth. Moreover, the used bandwidth determining unit 101 notifies the physical layer processing unit 110 of the determined bandwidth as necessary. In other words, when the bandwidth to be used is changed to a bandwidth that is different from the bandwidth that has been used previously, the used bandwidth determining unit 101 notifies the used bandwidth changing unit 116 in the physical layer processing unit 110 of the determined bandwidth. Moreover, for example, when the user changes the bandwidth by operating the GUI in a state where the device is operating, the used bandwidth determining unit 101 may determine the bandwidth to be used by the procedure similar to the above and immediately reflects the determined bandwidth.

After the used bandwidth determining unit 101 determines the bandwidth to be used by default, the used bandwidth determining unit 101 periodically queries the transmission managing unit 102 to acquire transmission rate information (information on the transmission rate when frames are transmitted to each of the terminals 20) with respect to each of the terminals 20 that are connected to the device at this point. The transmission rate depends on, for example, the communication scheme that is being used; therefore, the transmission rate changes when the communication scheme is changed. The transmission rate information does not need to be a value in units of bps and may be the frequency usage efficiency, or it may be expressed in any unit if the transmission rate does not change. In order to simplify the calculations, the value may be rounded. Furthermore, the embodiment may be such that index information on each of an MCS Index, a GI length, and a transmission bandwidth with respect to each of the terminals 20 or index information indicating the transmission rate are acquired from the transmission managing unit 102 and this is converted to the actual transmission rate.

Because the transmission rate with respect to each of the terminals 20 may change in real time, for example, as described in the following Equation (1), the average transmission rate with respect to each of the terminals 20 may be calculated by multiplying the periodically acquired values by coefficients and summing the products.

average transmission rate after updating=αₜ×average transmission rate before updating+(1−αₜ)×newly acquired transmission rate value (1)

αₜ: forgetting coefficient

When the used bandwidth determining unit 101 acquires the transmission rate information with respect to each of the terminals 20, the used bandwidth determining unit 101 then acquires an approximation of the system communication capacity when only transmission from the device to each of the terminals 20 is taken into consideration by weight averaging the transmission rates with respect to the terminals 20 between the terminals 20. The approximation of the system communication capacity is calculated, for example, in accordance with the following Equation (2).

$$system communication capacity approximation = {\sum }_{i = 1}^{n} {β}_{i} \times transmission {rate}_{i} \\ {\sum }_{i = 1}^{n} {β}_{i} = 1 \qquad ( 2 )$$

βᵢ: coefficient for terminal i

transmission rate i: transmission rate with respect to terminal i

The coefficient βi in Equation (2) may be calculated simply by using the following Equation (3) where it is assumed that the band occupation time of data frames to be transmitted to each of the terminals 20 is constant or it may be calculated by using the following Equation (4) by acquiring, via the transmission managing unit 102, the amount of data transmitted to each of the terminals 20 per unit time from the data frame transmission queue 106 and using the transmission rate with respect to each of the terminals 20.

$$\begin{matrix} {β}_{i} = 1 / n & ( 3 ) \\ {β}_{i} = \frac{amount of transmitted {data}_{i} / transmission {rate}_{i}}{{\sum }_{i = 1}^{n} ( amount of transmitted {data}_{i} transmission {rate}_{i} )} \\ amount of transmitted {data}_{i} \text{:} amount of transmitted data per unit of time with respect to terminal i & ( 4 )\end{matrix}$$

When the coefficient βi is calculated by using Equation (4), a weight of zero is assigned to the terminal 20 that is not communicating with the device (the wireless access point device 10). When all of the terminals are not communicating with the device, the calculation by using Equation (4) is not performed and the processes explained below are also not performed.

The used bandwidth determining unit 101 then compares the system communication capacity approximation calculated by using the above calculation with a predetermined threshold to determine the bandwidth to be used for transmission from the device and reception from each of the terminals 20, i.e., the upper limit of the bandwidth (hereinafter, referred to as a system bandwidth) to be used in the system.

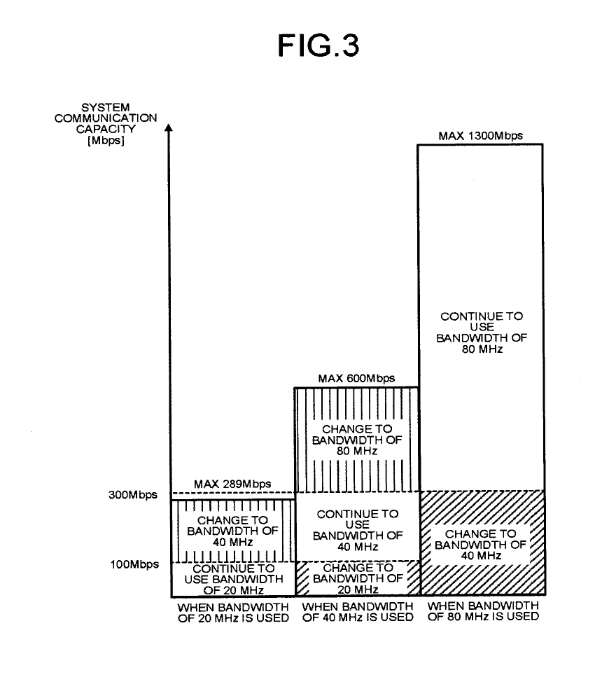

A specific example of the determination operation of the system bandwidth will be explained with reference to FIG. 3. In the present embodiment, for ease of explanation, an explanation will be given of a case where the number of available bandwidths is three, i.e., 20 MHz, 40 MHz, and 80 MHz. However, available bandwidths are not necessarily limited to these and can correspond to various combinations of bandwidths.

In the example illustrated in FIG. 3, the switching threshold between the 20-MHz bandwidth and the 40-MHz bandwidth is set to 100 Mbps and the switching threshold between the 40-MHz bandwidth and the 80-MHz bandwidth is set to 300 Mbps.

For example, in the case where the current system bandwidth is 40 MHz, when the system communication capacity approximation calculated by performing the above operation exceeds 300 Mbps, the used bandwidth determining unit 101 changes the system bandwidth to 80 MHz. On the other hand, when the system communication capacity approximation falls below 100 Mbps, the used bandwidth determining unit 101 changes the system bandwidth to 20 MHz. In a similar manner, in the case where the current system bandwidth is 20 MHz, when the calculated system communication capacity approximation exceeds 100 Mbps, the used bandwidth determining unit 101 changes the system bandwidth to 40 MHz. In the case where the current system bandwidth is 80 MHz, when the calculated system communication capacity approximation falls below 300 Mbps, the used bandwidth determining unit 101 changes the system bandwidth to 40 MHz.

When the used bandwidth determining unit 101 changes the upper limit of the bandwidth (system bandwidth), if it is necessary to once disconnect each of the terminals 20 communicating with the device at this point, the upper limit of the bandwidth may be changed after the data traffic with respect to each of the terminals 20 becomes a fixed threshold or less or after it is recognized that all of the terminals 20 are disconnected.

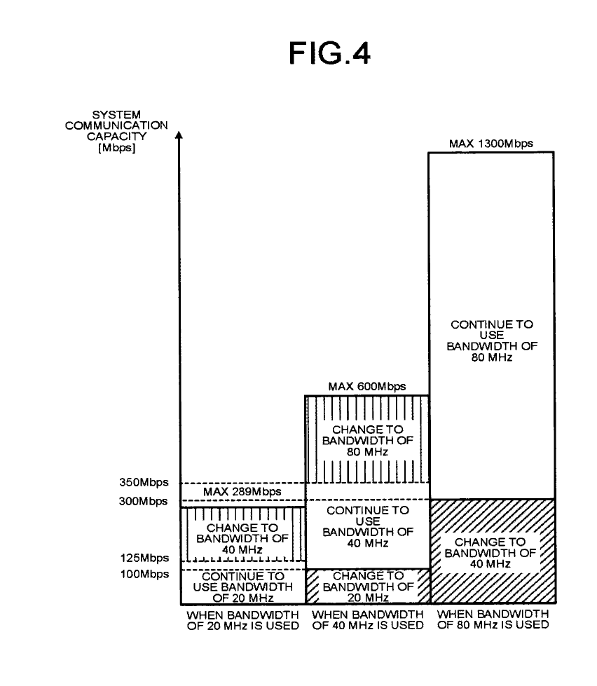

Moreover, as illustrated in FIG. 4, as a switching threshold for the system bandwidth, the threshold used when the bandwidth is increased and the threshold used when the bandwidth is reduced may be set separately. In the example in FIG. 4, the threshold used when the system bandwidth is increased from 20 MHz to 40 MHz is 125 Mbps, the threshold used when the system bandwidth is reduced from 40 MHz to 20 MHz is 100 Mbps, the threshold used when the system bandwidth is increased from 40 MHz to 80 MHz is 350 Mbps, and the threshold used when the system bandwidth is reduced from 80 MHz to 40 MHz is 300 Mbps. When the threshold used when the bandwidth is increased and the threshold used when the bandwidth is reduced are set separately, it is possible to prevent the bandwidth from being frequently changed when the system communication capacity approximation is around the threshold.

The system bandwidth determined by the above procedure is added, as information, to the data frames for the respective terminals 20 that accumulate in the data frame transmission queue 106 via the transmission managing unit 102 to be passed to the transmission processing unit 111 of the physical layer processing unit 110. The management frame generating unit 105 is notified of the system bandwidth via the transmission managing unit 102. In response to the instruction from the transmission managing unit 102, the management frame generating unit 105 generates management frames on the basis of the system bandwidth, received information on management frames, and other pieces of setting information (a description thereof is omitted for the present embodiment). The generated management frames are passed to the transmission processing unit 111 of the physical layer processing unit 110 via the management frame transmission queue 107. Furthermore, the used bandwidth determining unit 101 sets the system bandwidth in the used bandwidth changing unit 116 of the physical layer processing unit 110. The used bandwidth changing unit 116 in which the system bandwidth is set changes the setting in the physical layer processing unit 110 so as to communicate with the wireless client terminals 20 by using any of the 20-MHz processing unit 113, the 40-MHz processing unit 114, and the 80-MHz processing unit 115 corresponding to the set system bandwidth.

Next, the operation of the physical layer processing unit 110 will be explained.

When the used bandwidth changing unit 116 receives information on the system bandwidth from the MAC layer processing unit 100, the used bandwidth changing unit 116 selects the FFT (Fast Fourier Transform)/IFFT (Inverse FFT) size, the transmit power, the transmit filter, and the like to be used. In the present embodiment, the configuration in which the used bandwidth changing unit 116 is not present and the above settings are fixed without depending on the system bandwidth or are determined frame by frame is not eliminated.

(Frame Transmission Operation to Wireless Client Terminal 20)

In the physical layer processing unit 110, when the transmission processing unit 111 receives data frames or management frames from the MAC layer processing unit 100, the transmission processing unit 111 performs processes, such as FEC encoding and modulation, on the received frames and then passes the processed frames to the 20-MHz processing unit 113, the 40-MHz processing unit 114, or the 80-MHz processing unit 115. The 20-MHz processing unit 113, the 40-MHz processing unit 114, or the 80-MHz processing unit 115 that has received the transmitted frames from the transmission processing unit 111 performs an IFFT process, a transmit filtering process, and the like and transmits signals to the terminals 20 via the antenna 130. The transmission processing unit 111 cooperates with the reception processing unit 112 to count, for each of the terminals 20, the number of times an ACK with respect to each of the data frames transmitted to the terminals 20 is received and the number of times an ACK is not received and stores them as frame transmission success/failure information. The reception processing unit 112 may store the frame transmission success/failure information.

(Frame Reception Operation from Wireless Client Terminal 20)

In the physical layer processing unit 110, when wireless frames received via the antenna 130 are input to the 20-MHz processing unit 113, the 40-MHz processing unit 114, or the 80-MHz processing unit 115, the 20-MHz processing unit 113, the 40-MHz processing unit 114, or the 80-MHz processing unit 115 performs a receive filtering process, an FFT process, and the like on the input wireless frames, and the reception processing unit 112 performs processes, such as demodulation and FEC decoding. The reception processing unit 112 stores an RSSI value for each of the terminals 20 and passes the received frames including management frames to the MAC layer processing unit 100.

As described above, the wireless access point device 10 in the present embodiment calculates the approximation of the system communication capacity in accordance with the transmission rate with respect to each of the controlled wireless client terminals 20 and determines the bandwidth to be used by subjecting the calculated approximation to the determination based on thresholds. Accordingly, when the system communication capacity is reduced due to degradation of the communication quality, the bandwidth used in the system is reduced. Therefore, the communication is less subjected to external radio wave interference and thus a stable throughput can be provided. Moreover, the possibility of the device itself becoming a source of interference is reduced by reducing the bandwidth; therefore, it is possible to improve the transmission efficiency in the whole system that uses the same frequency band and includes other systems.

Moreover, it is determined whether it is necessary to change the bandwidth in accordance with the transmission rate determined on the basis of the information on the communication quality and the like instead of determining the need for a change of the bandwidth by using information (such as a frame error rate) whose value suddenly changes with changes in the modulation scheme or the like. Therefore, even in a system that uses the adaptive modulation, it is possible to correctly determine whether it is necessary to change the bandwidth.

Moreover, in the present embodiment, the wireless access point device 10 calculates the approximation of the system communication capacity by using the transmission rate with respect to each of the terminals 20 and determines the upper limit of the bandwidth to be used in the system by using the approximation. Therefore, when the present embodiment is used in a conventional wireless access point device, it is satisfactory to add a functional unit that performs a process for determining whether to change the bandwidth without changing the adaptive modulation control process; therefore, the present embodiment is incorporated extremely easily.

In the present embodiment, the system communication capacity approximation calculated by using Equation (2) described above is a value in which frame reception in the wireless access point device 10 is not taken into consideration; however, in view of the fact that there is not a significant difference in propagation environment between transmission and reception performed between the wireless access point device 10 and the terminals 20 except for special environments, the approximation is satisfactory.

### Second Embodiment

In the first embodiment, the bandwidth to be used in the system is determined by using only the transmission rate; however, in the present embodiment, the bandwidth to be used in the system is determined by using the reception rate in addition to the transmission rate. The configuration of the wireless communication system in the present embodiment is similar to that in the first embodiment (see FIG. 1).

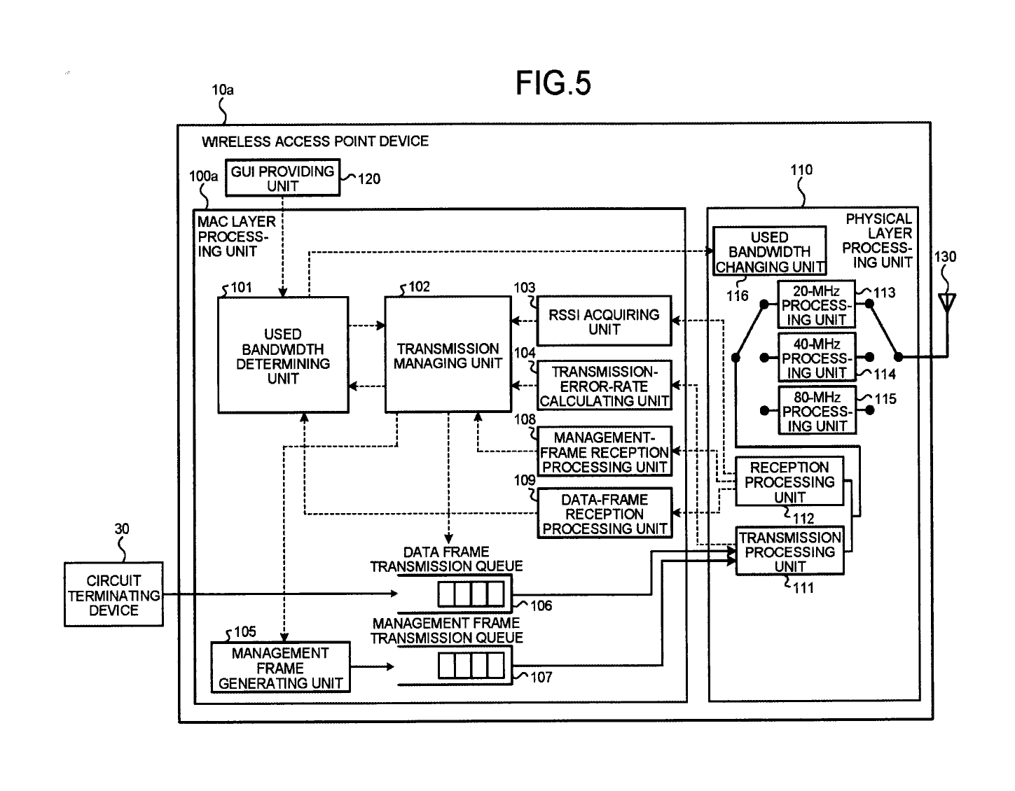

FIG. 5 is a diagram illustrating an example of the configuration of a wireless access point device in the second embodiment. As illustrated in FIG. 5, a wireless access point device 10a in the present embodiment is such that a data-frame reception processing unit 109 is added to the MAC layer processing unit 100 included in the wireless access point device 10 (see FIG. 2) in the first embodiment. Components common to the wireless access point device 10 in the first embodiment are denoted by the same reference numerals. In the present embodiment, the portions different from those in the first embodiment will be explained.

The data-frame reception processing unit 109 in an MAC layer processing unit 100a acquires reception rate information from the reception processing unit 112 of the physical layer processing unit 110. The reception rate information is information indicating the transmission rate at which the frames received from the wireless client terminals 20 are transmitted and, in a similar manner to the transmission rate information described in the first embodiment, it is index information on each of an MCS Index, a GI length, and a reception bandwidth of the received data frames, index information indicating the reception rate, or the like. The reception rate is determined on the wireless client terminal 20 side and the determination result is added to the data frames as reception rate information. The data-frame reception processing unit 109 appropriately acquires the reception rate information on each of the wireless client terminals 20 connected to the device from the reception processing unit 112 and updates the reception rate information.

In order to calculate an approximation of the system communication capacity used when the used band is determined, the used bandwidth determining unit 101 acquires the transmission rate information from the transmission managing unit 102 and acquires the reception rate information stored in the data-frame reception processing unit 109. When the reception rate information is index information on each of an MCS Index, a GI length, and a reception bandwidth acquired from the received frames from each of the terminals 20 or index information indicating the reception rate, the used bandwidth determining unit 101 converts it to the actual reception rate.

Because the reception rate with respect to each of the terminals 20 may change in real time, in a similar manner to the transmission rate described above, for example, as described in the following Equation (5), the average reception rate with respect to each of the terminals 20 may be calculated by multiplying the periodically acquired values by coefficients and summing the products.

average reception rate after updating=αᵣ×average reception rate before updating+(1−αᵣ)×newly acquired reception rate value (5)

αᵣ: forgetting coefficient

When the used bandwidth determining unit 101 acquires the transmission rate information and the reception rate information with respect to each of the terminals 20, the used bandwidth determining unit 101 then acquires an approximation of the system communication capacity by weight averaging the transmission rates and the reception rates with respect to the terminals 20 between the terminals 20. The approximation of the system communication capacity is calculated, for example, in accordance with the following Equation (6).

$$system communication capacity approximation = {\sum }_{i = 1}^{n} {β}_{i} \times transmission {rate}_{i} + {\sum }_{i = 1}^{m} {γ}_{i} \times reception {rate}_{i} \\ {\sum }_{i = 1}^{n} {β}_{i} + {\sum }_{i = 1}^{n} {γ}_{i} = 1 \qquad ( 6 )$$

βᵢ: coefficient for transmission rate with respect to terminal i,

γᵢ: coefficient for reception rate with respect to terminal i transmission rateᵢ: transmission rate with respect to terminal i, reception rateᵢ: reception rate with respect to terminal i

In a similar manner to the first embodiment, the coefficients βi and γi in Equation (6) may be calculated simply by using the following Equation (7) where it is assumed that the band occupation times of data frames to be transmitted to each of the terminals 20 and data frames to be received from each of the terminals 20 are constant or they may be calculated by using the following Equation (8) by measuring the amount of data transmitted and received to and from each of the terminals 20 per unit time in the transmission managing unit 102 and the data-frame reception processing unit 109 and acquiring the information thereon.

$$\begin{matrix} {β}_{i} = {γ}_{i} = 1 / 2 n & ( 7 ) \\ {β}_{i} = \frac{amount of transmitted {data}_{i} / transmission {rate}_{i}}{\begin{matrix}{\sum }_{i = 1}^{n} ( amount of transmitted {data}_{i} / transmission {rate}_{i} ) + \\ {\sum }_{i = 1}^{n} ( amount of received {data}_{i} / reception {rate}_{i} )\end{matrix}} \\ {γ}_{i} = \frac{amount of received {data}_{i} / reception {rate}_{i}}{\begin{matrix}{\sum }_{i = 1}^{n} ( amount of transmitted {data}_{i} / transmission {rate}_{i} ) + \\ {\sum }_{i = 1}^{n} ( amount of received {data}_{i} / reception {rate}_{i} )\end{matrix}} \\ amount of transmitted {data}_{i} \text{:} amount of transmitted data per unit of time with respect to terminal i \\ amount of received {data}_{i} \text{:} amount of received data per unit of time with respect to terminal i & ( 8 )\end{matrix}$$

Other processes are the same as those in the first embodiment. As described above, in the present embodiment, the system communication capacity is calculated while the reception rate from each of the wireless client terminals 20 is taken into consideration; therefore, the accuracy of the system communication capacity approximation is increased when compared with the first embodiment and thus the bandwidth can be changed more appropriately. Moreover, it is satisfactory to add a functional unit that calculates the reception rate to the configuration in the first embodiment; therefore, the present embodiment is incorporated extremely easily.

### Third Embodiment

For the wireless access point device in the present embodiment, consideration is given to the use of a DFS (Dynamic Frequency Selection) function when the system bandwidth is determined in the wireless access point devices in the first and second embodiments. The configurations of the wireless communication system and the wireless access point device are similar to those in the first or second embodiment (see FIG. 1, FIG. 2, or FIG. 5). In the present embodiment, only the portions different from those in the first and second embodiments will be explained.

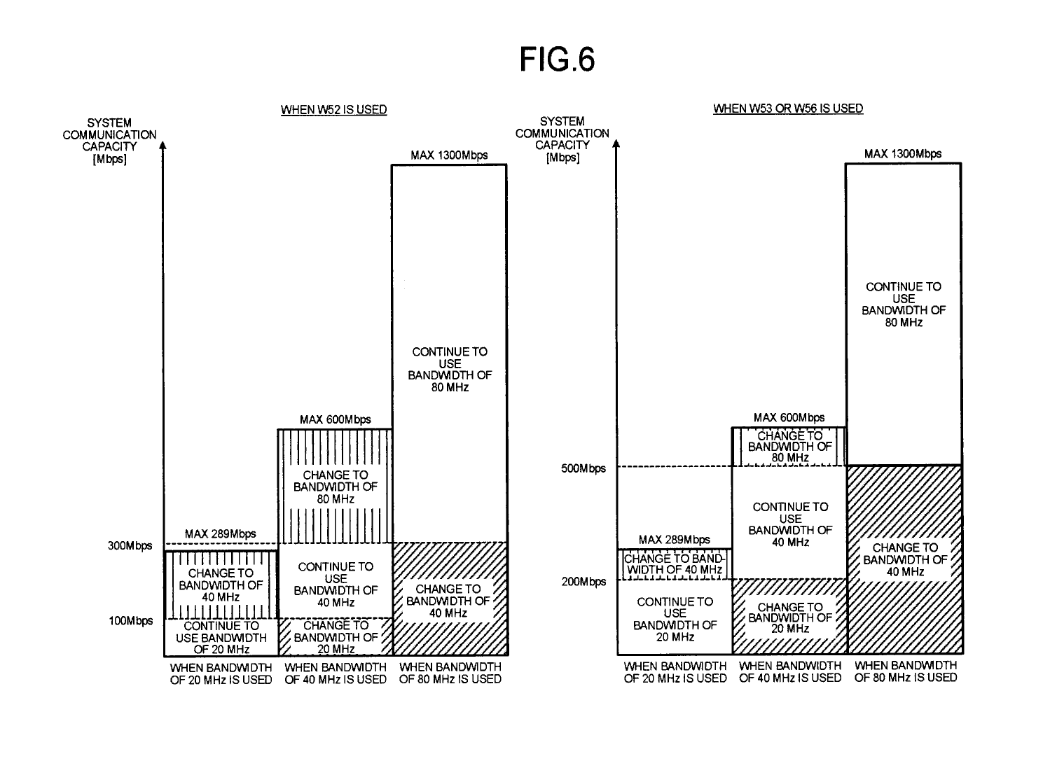

An explanation will be given of an operation for determining the system bandwidth with the use of the DFS function taken into consideration with reference to FIG. 6.

The DFS function is a function in which an interference wave, such as radar, is constantly monitored by the wireless access point device 10 side and the used frequency band is changed so that communication over the wireless LAN does not affect weather radar and the like. For example, in Japan, the 5.3-GHz band (W53) and the 5.6-GHz (W56), which are used in the 5-GHz band wireless LAN, overlap with the frequency bands used by various existing radars; therefore, it is necessary to use the DFS function. In contrast, the 5.2-GHz band (W52) is a standard with which it is not necessary to use the DFS function.

As described above, in the frequency band for which the DES function is used, when an interference wave, such as radar, is detected, the used frequency band is changed; therefore, when compared with the frequency band for which it is not necessary to use the DFS function, the probability of instantaneous interruption of the communication increases, particularly, when a wideband, such as 80 MHz or 160 MHz, is used. As a result, in an application that operates on the premise of the IP (Internet Protocol) communication with the network, the probability of the occurrence of an error increases. Therefore, in the wireless access point device in the present embodiment, the used bandwidth determining unit 101 recognizes the frequency band to be used on the basis of the wireless channel information notified from the GUI providing unit 120. When W53/W56 is used, for example, as illustrated in FIG. 6, the used bandwidth determining unit 101 changes the threshold for switching the system bandwidth between 20 MHz and 40 MHz to 200 Mbps and changes the threshold for switching the system bandwidth between 40 MHz and 80 MHz to 500 Mbps.

As described above, in the wireless access point device in the present embodiment, when the frequency band is used for which the DFS function is used, the threshold for switching the system bandwidth is changed to a threshold that is different from that in the normal state (when the frequency band for which the DFS function is not used is used). Specifically, when the frequency band is used for which the DFS function is used, the threshold is changed to a threshold that is higher than that in the normal state to increase the probability of selecting a narrow bandwidth. Accordingly, it is possible to reduce the probability that an automatic frequency band changing process using the DFS function is performed and thus a stable wireless communication environment can be provided.

### Fourth Embodiment

A wireless access point device according to the present embodiment is such that a power saving function is added to the wireless access point devices in the first to third embodiments and the system bandwidth is determined while the setting state of the power saving function is taken into consideration. The configurations of the wireless communication system and the wireless access point device are similar to those in the first or second embodiment (see FIG. 1, FIG. 2, or FIG. 5). In the present embodiment, only the portions different from those in the first to third embodiments will be explained.

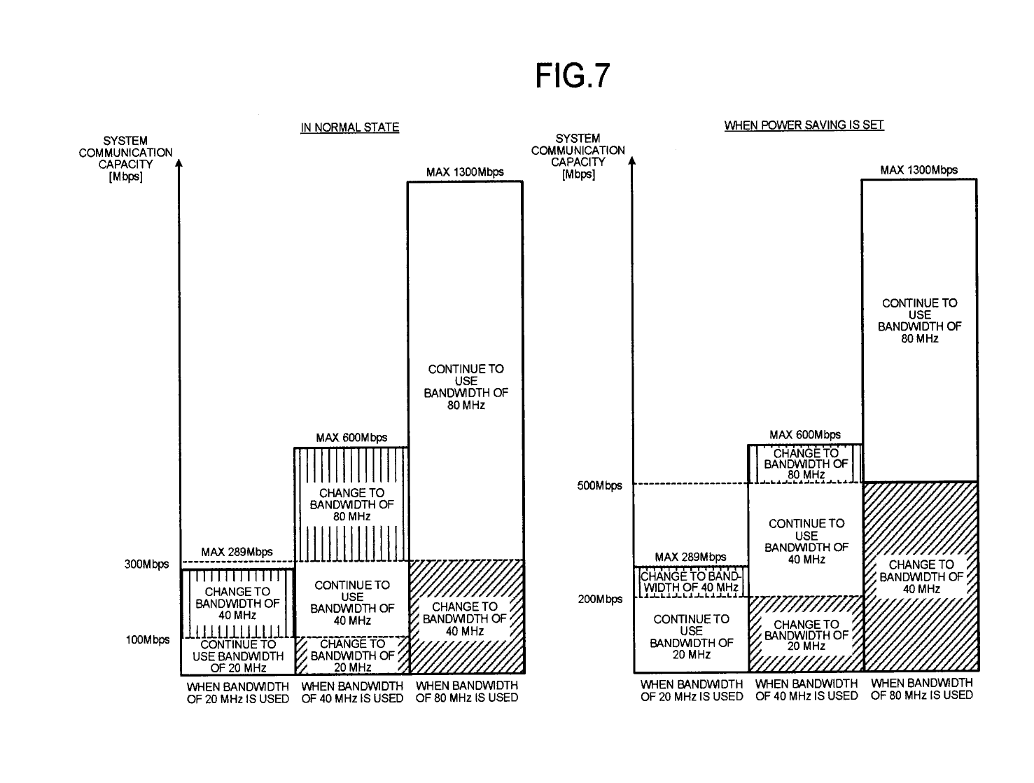

An explanation will be given of the operation for determining the system bandwidth with the setting state of the power saving function taken into consideration with reference to FIG. 7.

In the wireless access point device in the present embodiment, the used bandwidth determining unit 101 recognizes the time when the power saving is set on the basis of the power-saving setting information notified from the GUI providing unit 120 and, when the power saving is set, for example, changes the threshold for switching the system bandwidth between 20 MHz and 40 MHz to 200 Mbps and changes the threshold for switching the system bandwidth between 40 MHz and 80 MHz to 500 Mbps as illustrated in FIG. 7. It is not necessary that the information notified from the GUI providing unit 120 is the only information that triggers the setting of the power saving and, for example, the power saving may be set with the connection state between the wireless access point device 10 and the terminals 20 taken into consideration.

As described above, in a state where the power saving is set, the wireless access point device in the present embodiment changes the threshold for switching the system bandwidth to a threshold that is higher than that in the normal state (a state where the power saving is not set). Accordingly, in a state where the power saving is set, the system bandwidth is proactively reduced. Thus, it is possible to contribute to a reduction of the power usage.

### Fifth Embodiment

A wireless access point device according to the present embodiment is such that, the system bandwidth is determined in accordance with the interference power of the secondary channel in the wireless access point devices in the first to fourth embodiments. The configurations of the wireless communication system and the wireless access point device are similar to those in the first or second embodiment (see FIG. 1, FIG. 2, or FIG. 5). In the present embodiment, only the portions different from those in the first to fourth embodiments will be explained.

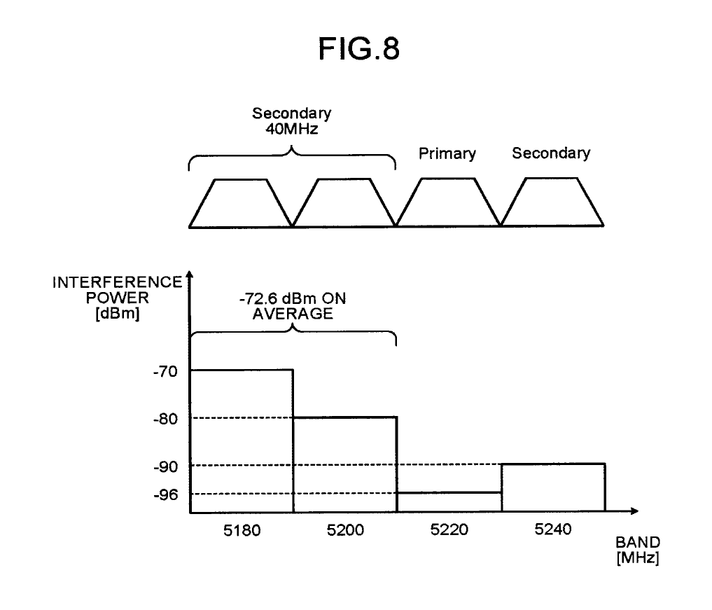

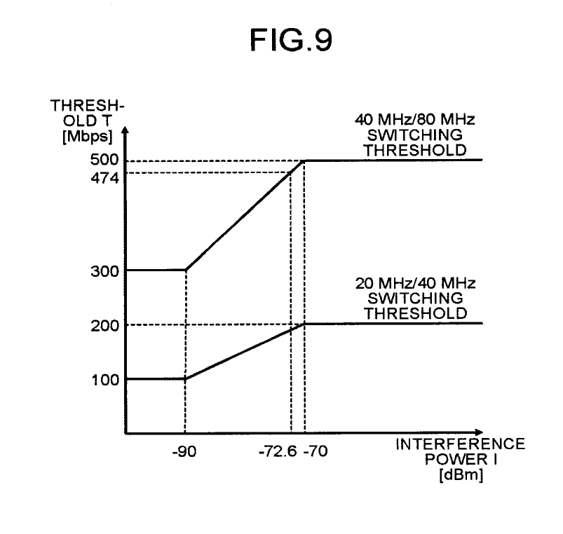

An explanation will be given of the operation for determining the system bandwidth in the wireless access point device in the present embodiment with reference to FIG. 8 and FIG. 9. In the wireless access point device in the present embodiment, the used bandwidth determining unit 101 acquires the interference power of the secondary channel measured when the device is started or operating. The method of acquiring the interference power is not specifically limited and the interference power may be acquired by any method.

FIG. 8 illustrates an example where a center frequency of 5220 MHz is used for the primary channel, the interference power of the secondary channel is −90 dBm, and the interference power of the secondary 40-MHz channel is −72.6 dBm on average. In such a case, the threshold for switching the system bandwidth between 20 MHz and 40 MHz is changed in accordance with the interference power of the secondary channel and the threshold for switching the system bandwidth between 40 MHz and 80 MHz is changed in accordance with the interference power of the secondary 40-MHz channel. For example, each threshold is changed in accordance with FIG. 9. In the example in FIG. 9, when the interference power is between −90 dBm and −70 dBm, the threshold is set in accordance with the interference power.

The relational equation of the 20 MHz/40 MHz switching threshold is expressed by the following Equation (9) and the relational equation of the 40 MHz/80 MHz switching threshold is expressed by the following Equation (10).

T=100(I≦−90),

T=100+5*(I+90)(−90<I<−70),

T=200(I≧−70), (9)

T=300(I≦−90),

T=300+10*(I+90)(−90<I<−70),

T=300(I≧−70), (10)

In the case of the example in FIG. 8, the 20 MHz/40 MHz switching threshold is set to 100 Mbps and the 40 MHz/80 MHz switching threshold is set to 474 Mbps.

As described above, the wireless access point device in the present embodiment sets the switching thresholds for the system bandwidth to values in accordance with the interference power of the secondary channel. Accordingly, it is possible to use scanned information on other channels and change the bandwidth used in the system more appropriately. Moreover, it is possible to reduce the probability of the communication performed by the wireless access point device and the wireless client terminal becoming a source of interference for other systems or other communications.

### INDUSTRIAL APPLICABILITY

As described above, the wireless access point device according to the present invention is useful for a wireless communication system in which the system bandwidth to be used is variable.

### REFERENCE SIGNS LIST

10, 10a wireless access point device, 20 wireless client terminal, 30 circuit terminating device, communication line, 100, 100a MAC layer processing unit, 101 used bandwidth determining unit, 102 transmission managing unit, 103 RSSI acquiring unit, 104 transmission-error-rate calculating unit, 105 management frame generating unit, 106 data frame transmission queue, 107 management frame transmission queue, 108 management-frame reception processing unit, 109 data-frame reception processing unit, 110 physical layer processing unit, 111 transmission processing unit, 112 reception processing unit, 113 20-MHz processing unit, 114 40-MHz processing unit, 115 80-MHz processing unit, 116 used bandwidth changing unit, 130 antenna.

1. A wireless access point device that is connected to one or more wireless client terminals and communicates with each of the wireless client terminals by using one of a plurality of bandwidths, the device comprising:
a transmission-rate determining unit that individually determines a transmission rate with respect to each of connected wireless client terminals;
a calculating unit that calculates an approximation of a system communication capacity on a basis of the transmission rate and number of the connected wireless client terminals; and
a bandwidth determining unit that determines a bandwidth to be used by subjecting the approximation to determination based on a threshold.

2. The wireless access point device according to claim 1, further comprising a reception-rate acquiring unit that acquires a reception rate, which is a transmission rate used by a wireless client terminal for transmission with respect to the device, from each of the wireless client terminals, wherein the calculating unit calculates the approximation on a basis of the transmission rate, the number of the connected wireless client terminals, and the reception rate.

3. The wireless access point device according to claim 1, wherein a threshold to be used for the determination based on a threshold is set to a different value in a case where communication is performed by using a frequency band for which a DFS function is used and in a case where communication is performed by using a frequency band for which a DFS function is not used.

4. The wireless access point device according to claim 3, wherein the threshold is set to a value such that a frequency with which a narrow bandwidth is used is increased in communication in which a frequency band is used for which a DFS function is used.

5. The wireless access point device according to claim 1, wherein a threshold to be used for the determination based on a threshold is set to a different value in a state where a power saving function is operated and in a state where a power saving function is not operated.

6. The wireless access point device according to claim 5, wherein the threshold is set to a value such that a frequency with which a narrow bandwidth is used is increased in communication in a state where a power saving function is operated.

7. The wireless access point device according to claim 1, wherein a threshold to be used for the determination based on a threshold is changed in accordance with interference power of a neighboring channel around a used channel.

8. The wireless access point device according to claim 7, wherein the threshold is set to a value such that a frequency with which a narrow bandwidth is used is increased as interference power of a neighboring channel increases.

9. A band control method of a wireless access point device that is connected to one or more wireless client terminals and communicates with each of the wireless client terminals by using one of a plurality of bandwidths, the method comprising:
a transmission-rate determining step of individually determining a transmission rate with respect to each of connected wireless client terminals;
a calculating step of calculating an approximation of a system communication capacity on a basis of the transmission rate and number of the connected wireless client terminals; and
a bandwidth determining step of determining a bandwidth to be used by subjecting the approximation to determination based on a threshold.
